(19) United States
(12) Patent Application Publication
(10) Pub. No.: US 2019/0270840 A1
(43) Pub. Date: Sep. 5, 2019

(54) THERMOPLASTIC POLYURETHANES WITH REDUCED TACKINESS

(71) Applicant: LUBRIZOL ADVANCED MATERIALS, INC., Cleveland, OH (US)

(72) Inventors: Umit G. Makal, Stow, OH (US); Romina Marin Bernabe, Terrassa (ES); Chetan M. Makadia, Strongsville, OH (US)

(21) Appl. No.: 16/308,497

(22) PCT Filed: Jun. 15, 2017
(86) PCT No.: PCT/US2017/037699

§ 371 Date: Dec. 10, 2018

Related U.S. Application Data
(60) Provisional application No. 62/355,065, filed on Jun. 27, 2016.

(51) Int. Cl. C08G 18/66; C08G 18/73; C08G 18/42; C08G 18/32; C08G 18/28

(52) U.S. Cl. CPC C08G 18/664; C08G 18/73; C08G 18/2825; C08G 18/3206; C08G 18/4277

(57) ABSTRACT

The present invention relates to novel thermoplastic polyurethane (TPU) compositions that have crystalline chain ends. The TPU compositions of the invention can provide improved resiliency, lower surface free energy, and/or reduced stickiness, while maintaining other desirable physical properties. The TPU compositions of the present invention are made from the reaction product of an aliphatic polyisocyanate, a polycaprolactone polyester polyol, an optional chain extender component, and a chain terminator component, which comprises a short chain crystalline compound containing a single functional group capable of terminating the chain of the thermoplastic polyurethane.

### FIELD OF THE INVENTION

The present invention relates to novel thermoplastic polyurethane (TPU) compositions that have crystalline chain ends. The TPU compositions of the invention provide reduced stickiness, while maintaining other desirable physical properties.

### BACKGROUND OF THE INVENTION

Thermoplastic polyurethane (TPU) compositions are highly useful materials that can provide an attractive combination of physical properties. TPUs may be generally described as segmented copolymers, having one or more low glass transition temperature (Tg) soft segments and one or more high Tg hard segments.

There is an ongoing need for TPU compositions that can be more easily processed, and which have improved processing windows, and more specifically, can be scaled to continuous commercial quantity processes. Many TPU compositions have very narrow processing windows, which means there are a very tight set of conditions under which they process well. Small changes in processing conditions, which cannot always be easily controlled, can lead to significant variations in product quality. Thus, there are many TPU compositions that can be made in the lab, and may have interesting combinations of properties, but which cannot be commercialized because they cannot be produced by continuous reactive extrusion. For example, some thermoplastic polyurethane materials can be very sticky and pellets formed therefrom will stick together. Often anti-blocking additives must be used to reduce stickiness. Such anti-blocking additives are generally in a fine powder form which is difficult to use in manufacturing and may present certain health and safety hazards. In addition, making thermoplastic polyurethane pellets that are inherently non-tacky can allow a processor to increase the drying temperature thereby shortening the processing time for the material.

Various embodiments of the invention described herein address one or more of the needs described above.

### SUMMARY OF THE INVENTION

The present invention provides a thermoplastic polyurethane (TPU) composition that includes the reaction product of (i) an aliphatic polyisocyanate component, (ii) a polycaprolactone polyester polyol component, (iii) optionally, a chain extender component, and (iv) a chain terminator component. The chain terminator component comprises a short chain crystalline compound containing more than 12 carbon atoms and a single NCO-reactive functional group capable of terminating the chain of a TPU resulting from the reaction of components (i), (ii), and optionally, (iii). The aliphatic polyisocyanate may be selected from aliphatic diisocyanates. In addition, the chain extender may be a diol or a diamine.

In one embodiment, the present invention provides a thermoplastic polyurethane composition which includes the reaction product of (i) an aliphatic polyisocyanate component, comprising H12MDI, (ii) a polycaprolactone polyester polyol component, (iii) optionally, a chain extender component, comprising 1,4-butane diol, and (iv) a chain terminator component comprising a short chain crystalline compound containing more than 12 carbon atoms and a single NCO-reactive functional group capable of terminating the chain of a TPU resulting from the reaction of components (i), (ii), and optionally, (iii).

In another embodiment, the present invention provides a thermoplastic polyurethane composition which includes the reaction product of (i) an aliphatic polyisocyanate component, comprising H12MDI, (ii) a polycaprolactone polyester polyol component, (iii) a chain extender component, comprising 1,4-butane diol, and (iv) a chain terminator component comprising a short chain crystalline compound containing more than 12 carbon atoms and a single NCO-reactive functional group capable of terminating the chain of a TPU resulting from the reaction of components (i), (ii), and (iii).

In one embodiment, the present invention provides a thermoplastic polyurethane composition which includes the reaction product of (i) an aliphatic polyisocyanate component, (ii) a polycaprolactone polyester polyol component, (iii) optionally, a chain extender component, and (iv) a chain terminator component comprising a short chain crystalline compound containing more than 12 carbon atoms and a single NCO-reactive functional group capable of terminating the chain of a TPU resulting from the reaction of components (i), (ii), and optionally, (iii). In this embodiment, the chain terminator component may have a weight average molecular weight of 350 to 1000. In addition, in this embodiment, the aliphatic polyisocyanate may be H12MDI.

In another embodiment, the present invention provides a thermoplastic polyurethane composition which includes the reaction product of (i) an aliphatic polyisocyanate component, (ii) a polycaprolactone polyester polyol component, (iii) a chain extender component, and (iv) a chain terminator component comprising a short chain crystalline compound containing more than 12 carbon atoms and a single NCO-reactive functional group capable of terminating the chain of a TPU resulting from the reaction of components (i), (ii), and (iii). In this embodiment, the chain terminator component may have a weight average molecular weight of 350 to 1000. In addition, in this embodiment, the aliphatic polyisocyanate may be H12MDI.

In one embodiment, the present invention provides a thermoplastic polyurethane composition which includes the reaction product of (i) an aliphatic polyisocyanate component, (ii) a polycaprolactone polyester polyol component, (iii) optionally, a chain extender component, and (iv) a chain terminator component comprising a short chain crystalline compound containing more than 12 carbon atoms and a single NCO-reactive functional group capable of terminating the chain of a TPU resulting from the reaction of components (i), (ii), and optionally, (iii), wherein the composition comprises 20 wt % to 50 wt % of the combination of the aliphatic polyisocyanate component and the chain extender component (also called the “hard segment” of the TPU) and 0.5 wt % to 6 wt % of the chain terminator component.

In another embodiment, the present invention provides a thermoplastic polyurethane composition which includes the reaction product of (i) an aliphatic polyisocyanate component, (ii) a polycaprolactone polyester polyol component, (iii) a chain extender component, and (iv) a chain terminator component comprising a short chain crystalline compound containing more than 12 carbon atoms and a single NCO-reactive functional group capable of terminating the chain of a TPU resulting from the reaction of components (i), (ii), and (iii), wherein the composition comprises 20 wt % to 50 wt % of the combination of the aliphatic polyisocyanate component and the chain extender component (also called the “hard segment” of the TPU) and 0.5 wt % to 6 wt %, for example, 1 wt % to 3 wt % of the chain terminator component.

The invention further provides TPU compositions where the functional group of the short chain crystalline compound is a hydroxyl (alcohol) functional group, a primary amine functional group, a secondary amine functional group, an anhydride functional group, an epoxy functional group, a thiol functional group, a carboxy (carboxylic acid) functional group, an isocyanate functional group, or a combination thereof.

The invention also provides a process of making the TPU compositions, including the steps of: (I) reacting (i) an aliphatic polyisocyanate component, (ii) a polycaprolactone polyester polyol component, (iii) optionally, a chain extender component, and (iv) the described chain terminator component; resulting in a TPU with crystalline end groups. The invention even further provides a process of making the TPU compositions, including the steps of: (I) reacting (i) an aliphatic polyisocyanate component, (ii) a polycaprolactone polyester polyol component, (iii) optionally, a chain extender component, and (iv) the described chain terminator component; resulting in a TPU with crystalline end groups.

The invention also provides a method of improving the process window of a TPU composition where the method includes the step of: (I) adding the described chain terminator component to a TPU reaction mixture, wherein the TPU reaction mixture comprises an aliphatic diisocyanate, a polycaprolactone polyester polyol, and, optionally, a chain extender. In some embodiments, the TPU comprises 20 wt % to 50 wt % hard segment and 0.5 wt % to 6 wt % chain terminator component. In one embodiment, where a chain extender is included, the TPU comprises 35 wt % to 50 wt % hard segment. In some embodiments, the TPU compositions of the invention can be produced using continuous production processes whereas prior to the application of the invention, TPU compositions like these could only be made in lab scale and/or batch process.

### DETAILED DESCRIPTION OF THE INVENTION

The TPU compositions of the present invention include the reaction product of (i) an aliphatic polyisocyanate component, (ii) a polycaprolactone polyester polyol component, (iii) optionally, a chain extender component, and (iv) a chain terminator component. The chain terminator component includes a short chain crystalline compound containing more than 12 carbon atoms and a single NCO-reactive functional group capable of terminating the chain of a thermoplastic polyurethane resulting from the reaction of components (i), (ii), and (iii).

The molar ratio of the NCO groups provided by the polyisocyanate component and the NCO reactive groups provided by the polycaprolactone polyester polyol and the chain extender components, for example —OH groups, may be from 0.92 to 1.08, or from 0.96 to 1.04, or from 0.98 to 1.02, or from 0.99 or 1.01, or even about 1. That is, the molar ratio of NCO groups over NCO reactive groups present in the reaction mixture used to prepare the described TPU may from 0.92 to 1.08, or from 0.96 to 1.04, or from 0.98 to 1.02, or from 0.99 or 1.01, or even about 1.

In some embodiments, the TPU is represented by the following structure:

AD-EₘD-PₙₓD-A

wherein each A is an end group derived from the mono-functional short chain crystalline compound; each D is a group derived from the polyisocyanate component; each E is derived from the chain extender component; each P is derived from the polyol component; each m is an integer from 0 to 15; each n is an integer from 1 to 20; and x is an integer from 1 to 65; wherein the segment in the brackets is composed of blocky or random (D-E) and (D-P) units.

In some embodiments, m in the structure above is from 0 to 15, or 0 to 10, or 0 to 5, or 1 to 15, or 5 to 15, or even 5 to 10. In some embodiments, n in the structure above is from 1 to 20, or 1 to 15, or 1 to 10, or 1 to 5, or 5 to 20, or 5 to 15, or 5 to 10, or 10 to 20, or even 10 to 15. In some embodiments, x, in the structure above is from 1 to 65, or 15 to 55, or 10 to 50, or 20 to 50, or 20 to 40, or even 25 to 35.

The number average molecular weight (Mn) of the TPU compositions described herein may be from 5,000 to 100,000 Daltons, for example, 20,000 to 90,000 Daltons, even further for example, 30,000 to 85,000 Daltons.

### The Polyisocyanate Component

The TPU compositions of the invention are made using (i) an aliphatic polyisocyanate component, which includes one or more polyisocyanates. In some embodiments, the polyisocyanate component includes one or more diisocyanates.

Examples of useful polyisocyanates include aliphatic diisocyanates such as isophorone diisocyanate (IPDI), hexamethylene diisocyanate (HDI), 1,4-cyclohexyl diisocyanate (CHDI), decane-1,10-diisocyanate, lysine diisocyanate (LDI), 1,4-butane diisocyanate (BDI), and dicyclohexylmethane-4,4′-diisocyanate (H12MDI). Mixtures of two or more aliphatic polyisocyanates may be used. In some embodiments, the polyisocyanate consists essentially of aliphatic diisocyanates. In some embodiments, the polyisocyanate consists of aliphatic diisocyanates. In some embodiments, the polyisocyanate comprises H12MDI. In some embodiments, the polyisocyanate consists essentially of or consists of H12MDI.

### The Chain Extender Component

The TPU compositions of the invention are optionally made using a chain extender component. Chain extenders include diols, diamines, and combination thereof. In some embodiments, the TPU composition of the present invention includes a chain extender.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) phenyl]propane (HEPP), heptanediol, nonanediol, dodecanediol, ethylenediamine, butanediamine, hexamethylenediamine, and hydroxyethyl resorcinol (HER), and the like, as well as mixtures thereof. In some embodiments, the chain extender includes BDO, HDO, or a combination thereof. In some embodiments, the chain extender includes BDO. Other glycols, such as aromatic glycols could be used, but in some embodiments the TPUs of the invention are essentially free of or even completely free of such aromatic glycols.

In some embodiments, the chain extender used to prepare the TPU includes a cyclic chain extender. Suitable examples include CHDM, HEPP, HER, and combinations thereof. In some embodiments, the chain extender used to prepare the TPU includes an aromatic cyclic chain extender, for example HEPP, HER, or a combination thereof. In some embodiments, the chain extender used to prepare the TPU includes an aliphatic cyclic chain extender, for example CHDM. In some embodiments, the chain extender used to prepare the TPU is substantially free of, or even completely free of aromatic chain extenders, for example aromatic cyclic chain extenders. In some embodiments, the chain extender used to prepare the TPU may be a polysiloxane, while in other embodiments, the TPU composition is substantially free of, or even completely free of polysiloxanes.

In some embodiments, the chain extender component, when present, includes ethylene glycol, butanediol, hexamethylenediol, pentanediol, heptanediol, nonanediol, dodecanediol, ethylenediamine, butanediamine, hexamethylenediamine, or a combination thereof. In one embodiment, the chain extender used in the TPU composition of the present invention comprises 1,4-butanediol. In one embodiment, the chain extender consists essentially of or consists of 1,4-butanediol.

### The Polyol Component

The TPU compositions of the invention are made using a polycaprolactone polyester polyol.

The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ε-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Useful examples include CAPA™ 2101A, a 1,000 number average molecular weight (Mn) linear polyester diol, CAPA™ 2202A, a 2,000 Mn linear polyester diol, and CAPA™ 2302A, a 3,000 Mn linear polyester diol, all of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5,000, or from 1,000 or even 2,000 to 4,000 or even 3,000.

In some embodiments, other polyols may be included in the composition, such as polyether polyols, other polyester polyols, polycarbonate polyols, and polysiloxane polyols. In some embodiments, the TPU composition of the present invention is substantially free of or free of other polyols other than polycaprolactone polyester polyols.

### The Chain Terminator Component

The TPU compositions of the invention are made using (iii) a chain terminator component. The chain terminator component includes a short chain crystalline compound containing more than 12 carbon atoms and a single NCO-reactive functional group capable of terminating the chain of a TPU resulting from the reaction of the aliphatic polyisocyanate component, the polycaprolactone polyester polyol, and the chain extender component.

In some embodiments, the short chain crystalline compound is a short chain crystalline polyolefin. By “short chain” it is meant that the crystalline compound contains less than 200 carbon atoms, or even less than 100, 75, 70, 63, 60 or even 50 carbon atoms, but always more than 12 carbon atoms. In some embodiments, the short chain crystalline compounds contain from 13 to 70, 20 to 70, 23 to 63, or even from 24 to 50 carbon atoms. Generally speaking, the short chain crystalline compounds are linear.

The single functional group of the short chain crystalline compound may be an NCO-reactive functional group located at a terminal position within the crystalline compound. In other embodiments, the single functional group may be described as an active-hydrogen functional group, again located at a terminal position within the crystalline compound. Suitable functional groups include a hydroxyl (alcohol) functional group, a primary amine functional group, a secondary amine functional group, an anhydride functional group, an epoxy functional group, a thiol functional group, a carboxy (carboxylic acid) functional group, an isocyanate functional group, or a combination thereof.

In some embodiments, the short chain crystalline compound is a compound with an amine functional group, a carboxylic acid functional group, or a hydroxyl (alcohol) functional group. In some embodiments, the short chain crystalline compound is a hydroxyl (alcohol) functional group. In some embodiments, isocyanate functional groups are excluded from the invention that is the short chain crystalline compound may be essentially free of or even completely free of isocyanate functional groups, including diisocyanate functional groups.

In some embodiments, the short chain crystalline compound comprises one or more alpha-hydroxy terminated polyalphaolefins or ethoxylated versions thereof. Useful polyalphaolefins include polyethylene, polypropylene, poly(ethylene-co-alphaolefin) copolymer, poly(propylene-co-alphaolefin) copolymer, or any combination thereof.

It is important that the short chain crystalline compound have a single functional group, as the mono-functional nature of the compound is required in order to control the stoichiometry of the TPU forming reaction. If the short chain crystalline compound is not mono-functional (if it contains more than one functional group), it will not act as a chain terminator, but rather as an additional chain extender. It is understood that some amount of multi-functional material may be present in the short chain crystalline compound, however the present invention contemplates the chain terminator component being at least mostly mono-functional short chain crystalline compounds, and in some embodiments at least 70, 80, 90, or even 99.5 percent by weight mono-functional short chain crystalline compounds. In still other embodiments, the chain terminator component is essentially free of or even completely free of multi-functional compounds.

In some embodiments, the chain terminator component is essentially free of or even completely free of crystalline hydrocarbon waxes.

In some embodiments, the chain terminator component includes polyethylene mono alcohols, ethoxylated polyethylene mono alcohols, carboxylic acid terminated polyethylene, or any combination thereof.

Commercial examples of such mono-functional short chain crystalline compounds useful in the present invention include UNILIN™ alcohols, UNITHOX™ alcohols, and UNICID™ acids, all of which are commercially available from Baker Hughes. UNILIN™ 350 is a C33 crystalline mono-alcohol chain terminator. UNILIN™ 700 is a C63 crystalline mono-alcohol chain terminator. Other commercially available chain terminator components are ACCULINOL™ alcohol and ACCUCID™ alcohol available from IGI, Inc.

The TPU of the invention may be prepared by a process that includes the steps of: (I) reacting (i) the aliphatic polyisocyanate component, (ii) the polycapropactone polyester polyol intermediate, (iii) the chain extender component, and (iv) the chain terminator component. The resulting TPU has crystalline end groups where the short chain crystalline compound of the chain terminator component forms the end groups of the TPU chains. Any of the TPU materials described herein may be made by this process.

The described process for preparing the TPU of the invention includes both the “pre-polymer” process and the “one shot” process, in either a batch or continuous manner. That is, in some embodiments the TPU may be made by reacting the components together in a “one shot” polymerization process wherein all of the components are added together simultaneously or substantially simultaneously to a reactive extruder and reacted to form the TPU. While in other embodiments, the TPU may be made by first reacting the aliphatic polyisocyanate component with some portion of the polycaprolactone polyester polyol component forming a pre-polymer, and then completing the reaction by reacting the pre-polymer with the remaining reactants, resulting in the TPU.

In some embodiments, the components used in the preparation of the TPU are essentially free of or even completely free of maleated materials, including for example maleated polyolefins. In some embodiments, the components used in the preparation of the TPU are essentially free of or even completely free of thermoplastics, except for the TPU materials of the invention. In some embodiments, the TPU of the invention is made via a prepolymer process where a single prepolymer composition is used. In some embodiments, the TPU of the invention is made via continuous process.

### Additional Components

The TPU compositions of the invention may also include one or more additional components.

In some embodiments, the additional component is a flame retardant. Suitable flame retardants are not overly limited and may include a boron phosphate flame retardant, a magnesium oxide, a dipentaerythritol, a polytetrafluoroethylene (PTFE) polymer, or any combination thereof. In some embodiments, this flame retardant may include a boron phosphate flame retardant, a magnesium oxide, a dipentaerythritol, or any combination thereof. A suitable example of a boron phosphate flame retardant is BUDIT 326, commercially available from Budenheim USA, Inc. When present, the flame retardant component may be present in an amount from 0 to 10 weight percent of the overall TPU composition, in other embodiments from 0.5 to 10, or from 1 to 10, or from 0.5 or 1 to 5, or from 0.5 to 3, or even from 1 to 3 weight percent of the overall TPU composition.

The TPU compositions of the invention may also include additional additives, which may be referred to as a stabilizer. The stabilizers may include antioxidants such as phenolics, phosphites, thioesters, and amines, light stabilizers such as hindered amine light stabilizers and benzothiazole UV absorbers, and other process stabilizers and combinations thereof. In one embodiment the preferred stabilizer is Irganox 1010 from Ciba-Geigy Corp. and Naugard 445 from Chemtura. The stabilizer is used in the amount from about 0.1 weight percent to about 5 weight percent, in another embodiment from about 0.1 weight percent to about 3 weight percent, and in another embodiment from about 0.5 weight percent to about 1.5 weight percent of the TPU composition.

In addition, various conventional inorganic flame retardant components may be employed in the TPU composition. Suitable inorganic flame retardants include any of those known to one skilled in the art, such as metal oxides, metal oxide hydrates, metal carbonates, ammonium phosphate, ammonium polyphosphate, calcium carbonate, antimony oxide, clay, mineral clays including talc, kaolin, wollastonite, nanoclay, montmorillonite clay which is often referred to as nano-clay, and mixture thereof. In one embodiment the flame retardant package includes talc. The talc in the flame retardant package promotes properties of high LOI. The inorganic flame retardants may be used in the amount from 0 to about 30 weight percent, from about 0.1 weight percent to about 20 weight percent, in another embodiment about 0.5 weight percent to about 15 weight percent of the total weight of the TPU composition.

Still further optional additives may be used in the TPU compositions of the invention as well. The additives include colorants, antioxidants (including phenolics, phosphites, thioesters, and/or amines), antiozonants, stabilizers, inert fillers, lubricants, inhibitors, hydrolysis stabilizers, light stabilizers, hindered amines light stabilizers, benzotriazole UV absorber, heat stabilizers, stabilizers to prevent discoloration, dyes, pigments, inorganic and organic fillers, reinforcing agents and combinations thereof.

All of the additives described above may be used in an effective amount customary for these substances. The non-flame retardants additives may be used in amounts of from about 0 to about 30 weight percent, in one embodiment from about 0.1 to about 25 weight percent, and in another embodiment about 0.1 to about 20 weight percent of the total weight of the TPU composition.

These additional additives can be incorporated into the components of, or into the reaction mixture for, the preparation of the TPU resin, or after making the TPU resin. In another process, all the materials can be mixed with the TPU resin and then melted or they can be incorporated directly into the melt of the TPU resin.

### INDUSTRIAL APPLICATION

In some embodiments, the present invention provides TPU compositions that have improved processing windows. The stickiness and/or tackiness is one aspect of processing. Stickiness and similar properties make it much harder to process TPU compositions, and at some point the processing issues become so great that the TPU composition cannot be processed effectively. Such processing problems can be a significant barrier to producing some TPU compositions.

By reducing the stickiness of the TPU composition, the processing window for these materials can be greatly improved. One benefit of having less sticky TPU compositions is that during processing the drying temperatures for the pellets can be increased, resulting in time and cost savings. In addition, when the TPU is inherently less sticky, the use of fine powdered anti-blocking additives can be reduced or eliminated. Thus, in one useful embodiment, the present invention comprises thermoplastic polyurethane pellets or thermoplastic polyurethane extruded films comprising the reaction product of (i) an aliphatic polyisocyanate component, (ii) a polycaprolactone polyester polyol component, (iii) a chain extender component, and (iv) a chain terminator component comprising a short chain crystalline compound containing more than 12 carbon atoms and a single NCO-reactive functional group capable of terminating the chain of a TPU resulting from the reaction of components (i), (ii), and (iii), wherein the composition, pellets and/or films are substantially free of fine powder anti-blocking additives.

The less sticky, more processable TPU compositions of the invention may be described as TPU composition comprising the reaction product of (i) an aliphatic polyisocyanate component, (ii) a polycarbonate polyester polyol component, (iii) a chain extender component, and (iv) the described chain terminator component. While not wishing to be bound by theory, it is believed that the presence of the described chain terminator component acts to reduce the negative limitations described above, improving the processability, and so broadening the processing window of the resulting TPU.

In some embodiments, these TPU compositions with improved processability windows are made from an aliphatic diisocyanate, a polycaprolactone polyester polyol, a diol chain extender, along with the short chain crystalline chain terminator.

In some embodiments, the TPU compositions of the present invention comprise about 20 wt % to about 50 wt % hard segment, for example about 35 wt % to about 50 wt % hard segment. The hard segment is defined as the amount of the aliphatic polyisocyanate and the optional chain extender component combined.

In some embodiments, the TPU compositions of the present invention comprise about 0.5 wt % to about 6 wt % of the short chain crystalline chain terminator component, for example about 1 wt % to about 3 wt %.

In some embodiments, the TPU composition has a Shore hardness of 50A to 90A. In some embodiments, the TPU composition has a Shore hardness of 60A to 90A. In some of these embodiments, the hardness level is achieved without the use of a plasticizer (the TPU composition may be free of any plasticizer).

The highly non-polar crystalline chain terminators in the TPU composition of the present invention micro-phase separate as additional crystalline, high modulus nano-domains in the aliphatic TPU matrix so that the final aliphatic TPU exhibits crystallization transitions when thermally analyzed with i.e. DSC. We believe this has not been previously observed as such TPU structures are usually amorphous due to insufficient micro-phase separation. Such behavior provides the TPU of the present invention with additional beneficial properties that have been mentioned above.

### Examples

The invention will be further illustrated by the following examples, which sets forth particularly advantageous embodiments. While the examples are provided to illustrate the invention, they are not intended to limit it.

### Examples

A set of examples is prepared to demonstrate the non-tacky TPU compositions of the invention. The examples of this set are plasticizer free TPU compositions. TPU compositions were prepared using the wt % of components as shown in Table 1.

TABLE 1

| | EX A | | | | | | | | | |
|---|---|---|---|---|---|---|---|---|---|---|
| Ingredients (wt %) | (Comp) | EX 1 | EX 2 | EX 3 | EX 4 | EX 5 | EX 6 | EX 7 | EX 8 | EX 9 |
| H12MDI | 40 | 39 | 39 | 38 | 39 | 39 | 38 | 40 | 39 | 39 |
| CAPA ™ MW1000 | 49 | 49 | 49 | 49 | 49 | 49 | 49 | 49 | 49 | 49 |
| 1,4 BDO | 9 | 9 | 9 | 8 | 9 | 9 | 8 | 9 | 9 | 9 |
| Unilin ™ 350 | | | | | 1 | 2 | 3 | | | |
| Unilin ™ 425 | | | | | | | | 0.5 | 1 | 1.5 |
| Unilin ™ 700 | | 1 | 2 | 3 | | | | | | |
| Additives | 2 | 2 | 2 | 2 | 2 | 2 | 2 | 2 | 2 | 2 |
| Equivalent % of | 0.00 | 0.6% | 1.2% | 2.0% | 1.2% | 2.4% | 4.1% | 0.5% | 0.9% | 1.4% |
| Unilin in TPU | | | | | | | | | | |

Table 2 shows the measured melting temperature, crystallization temperature, and coefficient of friction data for the Examples of Table 1.

TABLE 2

| | EX A | EX 1 | EX 2 | EX 3 | EX 4 | EX 5 | EX 6 | EX 7 | EX 8 | EX 9 |
|---|---|---|---|---|---|---|---|---|---|---|
| Melting Peak (° C.) | 105.1 | 108.4 | 103.1 | 108.4 | 115.1 | 115.1 | 113.6 | 104.4 | 107.1 | 105.7 |
| Recrystallization Peak (° C.) | No peak | 71.1 | 70.4 | 69.5 | 57.4 | 57.6 | 60.7 | 61.4 | 63.8 | 67.6 |
| Recrystallization Enthalpy (J/g) | — | 1.0 | 2.4 | 3.8 | 0.6 | 1.2 | 1.1 | 0.1 | 0.1 | 0.3 |
| Static COF | 3.56 | 1.98 | 2.33 | Not Tested | 2.01 | 1.91 | 2.16 | 3.01 | 2.72 | 2.07 |
| Variation | 0 | −44 | −35 | | −43 | −46 | −39 | −15 | −23 | −42 |
| Kinetic COF | 2.63 | 1.04 | 1.23 | Not Tested | 1.52 | 1.34 | 1.35 | 1.84 | 1.80 | 1.56 |
| % Reduction | 0 | −60 | −53 | | −42 | −49 | −49 | −30 | −32 | −40 |

The data of Table 2 shows the inventive compositions of Examples 1-9 show a significant reductions in both Static Coefficient of Friction and Kinetic Coefficient of Friction as measured by ASTM D1894. Such measurements show that the inventive compositions are far less sticky that Comparative Example A and therefore would have increased processability. In addition, this data shows the inventive compositions of Examples 1-9 exhibit recrystallization transitions with useful and unexpected crystallization enthaphy values whereas, as expected, the comparative H12MDI aliphatic diisocyanate based samples do not show any such transition. This suggests that the comparative examples have an amorphous morphology rather than the crystalline morphology of the inventive examples. The crystalline morphology observed for the inventive examples is due to the crystallization of micro-phase separated crystalline chain end-rich phase. Such morphology was unexpected for an H12MDI based aliphatic TPU.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about”. Except where otherwise indicated, all numerical quantities in the description specifying amounts or ratios of materials are on a weight basis. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration. All of the embodiments of the invention described herein are contemplated from and may be read from both an open-ended and inclusive view (i.e. using “comprising of” language) and a closed and exclusive view (i.e. using “consisting of” language).

1. A thermoplastic polyurethane composition comprising the reaction product of (i) an aliphatic polyisocyanate component, (ii) a polycaprolactone polyester polyol intermediate, (iii) optionally, a chain extender component, and (iv) a chain terminator component;
wherein the chain terminator component comprises a short chain crystalline compound containing more than 12 carbon atoms and a single NCO-reactive functional group capable of terminating the chain of a thermoplastic polyurethane resulting from the reaction of the aliphatic polyisocyanate, the polycaprolactone polyester polyol, and the chain extender.

2. The thermoplastic polyurethane composition of claim 1 wherein the functional group of the short chain crystalline compound is an active-hydrogen functional group located at a terminal position within the crystalline compound.

3. The thermoplastic polyurethane composition of claim 1 wherein the functional group of the short chain crystalline compound is a hydroxyl (alcohol) functional group, a primary amine functional group, a secondary amine functional group, an anhydride functional group, an epoxy functional group, a thiol functional group, a carboxy (carboxylic acid) functional group, an isocyanate functional group, or a combination thereof.

4. The thermoplastic polyurethane composition of claim 1 wherein the short chain crystalline compound is a polyolefin that contains from 20 to 70 carbon atoms

5. The thermoplastic polyurethane composition of claim 1 wherein the short chain crystalline compound comprises one or more alpha-hydroxy terminated polyalphaolefins or ethoxylated versions thereof;
wherein the polyalphaolefin comprises a polyethylene, a polypropylene, a poly(ethylene-co-alphaolefin) copolymer, a poly(propylene-co-alphaolefin) copolymer, or any combination thereof.

6. The thermoplastic polyurethane composition of claim 1 wherein the thermoplastic polyurethane is represented by the following structure:
AD-EₘD-PₙₓD-A
wherein each A is an end group derived from the mono-functional short chain crystalline compound; each D is a group derived from the polyisocyanate component; each E is derived from the chain extender component; each P is derived from the polyol component; each m is an integer from 0 to 15; each n is an integer from 1 to 20; and x is an integer from 1 to 65; wherein the segment in the brackets is composed of blocky or random (D-E) and (D-P) units.

7. The thermoplastic polyurethane composition of claim 1 wherein the aliphatic polyisocyanate component comprises H12MDI.

8. The thermoplastic polyurethane composition of claim 1 wherein the chain extender component comprises a diol, a diamine, or a combination thereof.

9. The thermoplastic polyurethane composition of claim 8, wherein the chain extender component is present and comprises 1,4-butandiol.

10. The thermoplastic polyurethane composition of claim 1 wherein the thermoplastic polyurethane composition has a Shore hardness of about 50A to about 90A.

11. A process of making a thermoplastic polyurethane composition comprising the steps of: (I) reacting (i) an aliphatic polyisocyanate component, (ii) a polycaprolactone polyester polyol intermediate, (iii) optionally, a chain extender component, and (iv) a chain terminator component;
wherein the chain terminator component comprises a short chain crystalline compound containing a single functional group capable of terminating the chain of a thermoplastic polyurethane resulting from the reaction of the aliphatic polyisocyanate component, the polycaprolactone polyester polyol intermediate, and the chain extender component;
resulting in a thermoplastic polyurethane with crystalline end groups.

12. A method of improving the process window of a thermoplastic polyurethane composition said method including the step of: (I) adding a chain terminator component to a thermoplastic polyurethane reaction mixture, wherein the thermoplastic polyurethane reaction mixture comprises an aliphatic polyisocyanate component, a polycaprolactone polyester polyol intermediate, and, optionally, a chain extender component;
wherein the chain terminator component comprises a short chain crystalline compound containing more than 12 carbon atoms and a single NCO-reactive functional group capable of terminating the chain of a thermoplastic polyurethane resulting from the reaction of the aliphatic polyisocyanate component, the polycaprolactone polyester polyol intermediate, and the optional chain extender component.

13. A method of reducing the coefficient of friction of a thermoplastic polyurethane composition said method including the step of: (I) adding a chain terminator component to a thermoplastic polyurethane reaction mixture, wherein the thermoplastic polyurethane reaction mixture comprises an aliphatic polyisocyanate component, a polycaprolactone polyester polyol intermediate, and, optionally, a chain extender component;
wherein the chain terminator component comprises a short chain crystalline compound containing more than 12 carbon atoms and a single NCO-reactive functional group capable of terminating the chain of a thermoplastic polyurethane resulting from the reaction of the aliphatic polyisocyanate component, the polycaproplactone polyester polyol intermediate, and the optional chain extender component;
resulting in a thermoplastic polyurethane with a coefficient of friction lower than that of a corresponding thermoplastic polyurethane made without the chain terminator component.
